(19) United States
(12) Patent Application Publication
(10) Pub. No.: US 2011/0151881 A1
(43) Pub. Date: Jun. 23, 2011

(54) TECHNIQUES FOR FRACTIONAL FREQUENCY REUSE IN WIRELESS NETWORKS

(76) Inventors: JOEY CHOU, Scottsdale, AZ (US); Talwar Shilpa, Los Altos, CA (US); Kuilin Chen, Beijing (CN)

(21) Appl. No.: 12/646,415

(22) Filed: Dec. 23, 2009

(51) Int. Cl. H04W 16/00

(52) U.S. Cl. 455/447

(57) ABSTRACT

Methods and apparatuses for Fractional frequency reuse (FFR). A reuse factor of one (f=1) may be used to serve mobile stations located in inner cell regions that do not experience significant inter-cell interference (ICI) and a reuse factor of less than one (f<1) may be used for mobile stations located near the cell edge that tend to experience higher levels of ICI. Dynamic allocation of frequency partitions and adjustment of power levels for each base station sector are provided in order to avoid collisions between neighboring base station sectors and achieve improved capacity and performance. Load balancing may also be provided.

### TECHNICAL FIELD

Embodiments of the invention relate to wireless communications. More particularly, embodiments of the invention relate to techniques for fractional frequency reuse in cellular wireless networks.

### BACKGROUND

The increasing complexity and dynamic environment in current mobile networks often require constant analysis, provisioning and tuning to achieve optimal operation. Because the networks can include equipment spread over great geographical areas and a large number of parameters are monitored and modified, human-based optimization can quickly become very difficult to achieve.

Self-optimizing networks address this shortcoming by allowing network components to measure various conditions and parameters, and modify operational parameters in response to these measurements. While the generic concept of a self-optimizing network has been used in mobile wireless networks, current technologies still suffer from various shortcomings and deficiencies.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual diagram of one embodiment of a wireless network having multiple base stations and multiple mobile stations.

FIG. 2 illustrates an example of FFR partitions for frequency reuse factors of 1 for inner cell mobile stations and ⅓ for outer cell mobile stations.

FIG. 3 is a conceptual illustration of multiple adjoining cells in a mobile wireless network utilizing fractional frequency reuse strategies.

FIG. 4 is an example illustration of a parameter sampling that may be used for traffic load allocation.

FIG. 5 is a flow diagram of one embodiment of a technique for fractional frequency reuse.

FIG. 6 is a flow diagram of one embodiment of a technique for fractional frequency reuse.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

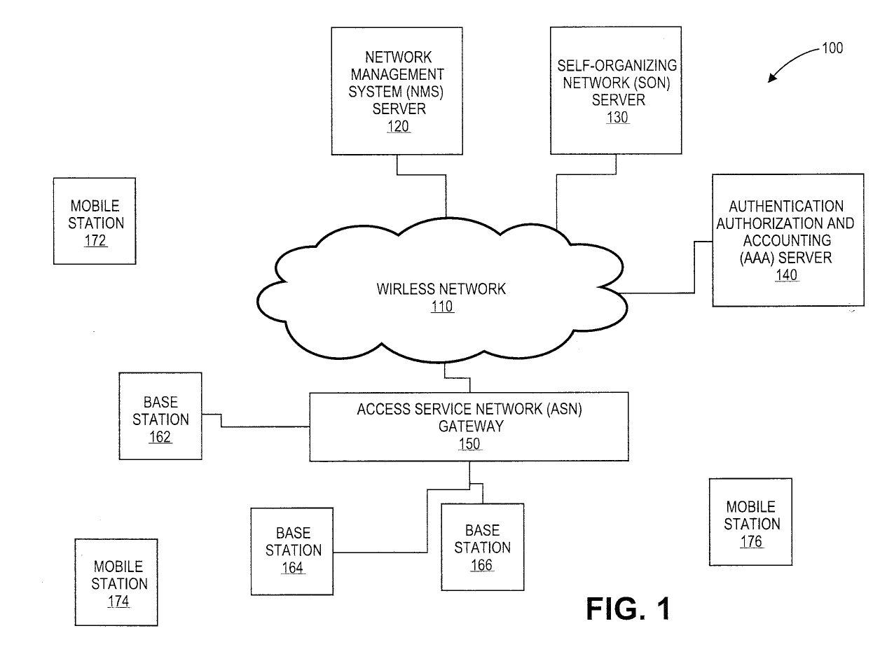

FIG. 1 is a conceptual diagram of one embodiment of a wireless network having multiple base stations and multiple mobile stations. In one embodiment, the wireless network of FIG. 1 is an IEEE 802.16-compliant wireless network. In alternate embodiments, other wireless protocols may be supported. IEEE 802.16 refers to IEEE Standard for Local and metropolitan area networks Part 16: Air Interface for Broadband Wireless Access Systems as well as related (e.g., other IEEE 802.16 standards) and subsequent standards.

Wireless network 110 is a collection of devices that provide wireless communications according to one or more wireless protocols, for example, IEEE 802.16. In the example embodiment of FIG. 1, wireless network 100 includes at least Network Management System (NMS) server 120, Self-Organizing Network (SON) server 130, Authentication, Authorization and Accounting (AAA) server 140 and Access Service Network (ASN) gateway 150. Multiple base stations (e.g., 162, 164 and 166) are coupled with ASN gateway 150. Multiple mobile stations (e.g., 172, 174 and 176) interact with the multiple base stations via the wireless communications protocols supported by wireless network 110.

In one embodiment, the interfaces between the base stations and the mobile stations are wireless. Various wireless protocols can be used, for example IEEE 802.16. The interconnections between NMS server 120, SON server 130, AAA server 140, ASN gateway 150 and base stations 162, 164 and 166 can be wired, wireless or any combination thereof. In one embodiment the communication between NMS server 120, SON server 130, AAA server 140, ASN gateway 150 and base stations 162, 164 and 166 utilizes Internet Protocol (IP)-based communications.

NMS server 120 functions to provide network functionality and configuration services. SON server 130 provides self-organizing network functionality. In one embodiment, SON server 130 provides a fractional frequency reuse strategy described herein. AAA server 140 provides authentication and authorization functionality for network 110. ASN gateway 150 provides an interface for base stations to connect to wireless network 110. Mobile stations 172, 174 and 176 can be any type of mobile device, for example, laptop computer, cellular telephones, netbook computers, that are configured to communicate using the wireless communication protocol of wireless network 110. The example of FIG. 1 includes only three base stations and only three mobile stations; however, any number of base stations and mobile stations can be supported.

Fractional frequency reuse (FFR) as described herein can be implemented with a reuse factor of one (f=1) to serve mobile stations located in inner cell regions that do not experience significant inter-cell interference (ICI) and a reuse factor of less than one (f<1) for mobile stations located near the cell edge that tend to experience higher levels of ICI. Described herein are mechanisms and techniques to dynamically allocate frequency partitions and adjust power levels for each base station sector in order to avoid collisions between neighboring base station sectors and achieve improved capacity, coverage, and performance. Load balancing may also be provided.

In order to adapt to dynamic changes in the wireless environment, FFR partition attributes are updated periodically. In one embodiment, the frequency of the updates is determined by a FFR Partition Update Interval parameter. In one embodiment, the update process is triggered by the base station.

In one embodiment, each base station has a timer or other mechanism that is used to manage operations over the interval. For example, the base stations may store a value for the FFR Partition Update Interval that indicates the length of the interval. The interval may be, for example, 60 minutes, 30 minutes, 10 minutes, etc. The interval times may be adapted based on actual and/or anticipated network conditions.

In one embodiment, when the interval ends, the base station reports measurements for the interval to SON server 130. In response, SON server 130 updates the FFR partition attributes in all base stations and causes the base stations to implement the new FFR partition attributes. These new FFR partition attributes continue until the next interval ends.

In one embodiment, all base stations report performance metrics to SON server 130 in a pre-selected interval. After receiving reports from all base stations, SON server 130 analyzes the performance metrics from the base stations for the previous interval and calculates frequency partitions and power levels to be sent to all base stations. All base stations implement the new frequency partitions and power levels as determined and provided by SON server 130. When a new base station is added to network 110, the new base station can request frequency partition and power level information form SON server 130.

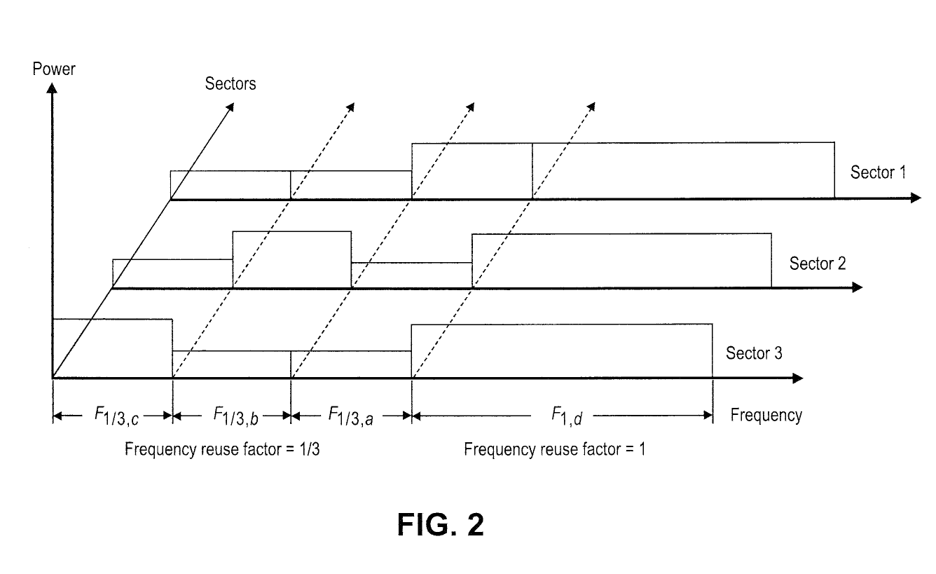

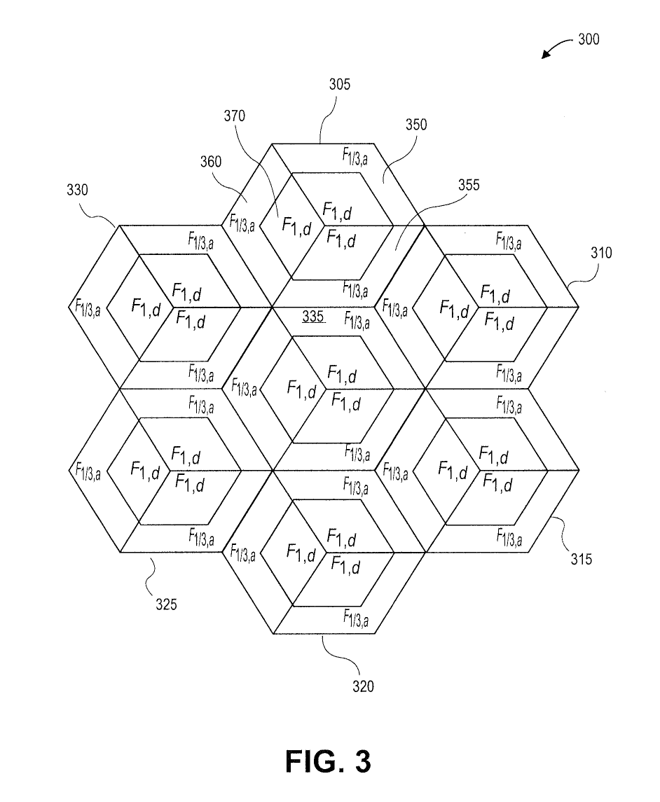

FIG. 2 illustrates an example of FFR partitions for frequency reuse factors of 1 for inner cell mobile stations and ⅓ for outer cell mobile stations. The frequency reuse factors of 1 and ⅓ are selected based on geographical interrelations of multiple cells in a wireless network, which is discussed in greater detail below with respect to FIG. 3. In other embodiments, other frequency reuse factors can be used, for example, 1 and ½, 1 and ¼, 1 and ⅕, 1 and ⅙, 1 and 1/7, 1 and ⅛, 1 and 1/9, 1 and 1/10, etc.

As illustrated in FIG. 2, for inner cell mobile stations the full frequency spectrum (F_{1,d}) is reused at full allocated power. The outer cell region is divided into three sectors (for a reuse factor of ⅓) each having a portion of the frequency spectrum at a full allocated power level and the remaining portion of the frequency spectrum at a reduced power level.

In the example of FIG. 2, for Sector 1, frequency spectrum F_{1/3,a} is transmitted at full allocated power while F_{1/3,b} and F_{1/3,c} are transmitted at reduced power levels. For Sector 2, frequency spectrum F_{1/3,b} is transmitted at full allocated power while F_{1/3,a} and F_{1/3,c} are transmitted at reduced power levels. Similarly, for Sector 3, frequency spectrum F_{1/3,c} is transmitted at full allocated power while F_{1/3,a} and F_{1/3,b} are transmitted at reduced power levels.

FIG. 3 is a conceptual illustration of multiple adjoining cells in a mobile wireless network utilizing fractional frequency reuse strategies. The example of FIG. 3 conceptually illustrates a distribution frequency partitions in a three-sector cellular network with F_{1/3,a}, F_{1/3,b} and F_{1/3,c} representing the frequency partitions for frequency reuse factors of ⅓ and with F_{1,d} representing the frequency partitions for frequency reuse factors of one. In one embodiment, the self-optimizing FFR mechanism reduces or avoids collisions among neighboring sectors by distributing frequency partitions and power levels for each base station.

In the conceptual illustration of FIG. 3, cells 305, 310, 315, 320, 325, 330 and 335 operate in a wireless network having at least one base station for each cell. The example of FIG. 3 is directed to frequency reuse factors of 1 and ⅓. In such an embodiment, each cell is divided into three sectors. For example, cell 305 includes sectors 350, 355 and 360. Further, each sector is divided into inner (370) and outer areas with frequencies and power levels allocated as described in FIG. 2.

Many factors can be considered in the selection of FFR partition parameters. Because the FFR strategy described herein primarily benefits outer cell mobile station users, one parameter that may be used is mobile station location distribution. However, some mobile stations, even though not located in the cell edge may experience poor Signal to Interference-plus-Noise Ratio (SINR) due to fading or shadowing. Therefore, SINR distribution parameters may also be considered.

In a mobile WiMAX (IEEE 802.16) embodiment, the number of mobile stations and the traffic load carried by a base station typically fluctuates continuously as mobile stations roam from cell to cell. In traditional frequency planning, the bandwidth allocated to each base station is fixed and can result in either traffic over load in some base stations or bandwidth waste in other base stations. FFR can support load balancing by taking in to account the sector traffic loads of each sector in the FFR frequency partitions selection process.

In one embodiment, the base station traffic metrics can be measured by counting the aggregate user data passing through in a fixed data sampling interval. The smaller the sampling interval the better resolution the traffic load data provides at the cost of higher overhead to the base station. In one embodiment, the sampling interval can be on the order of seconds. In alternate embodiments, the sampling interval can be on the order of minutes.

In one embodiment, some or all of the following parameters are provided by each base station to the SON server to be used for network self-optimizing functionality:
Base Station Identifier (BSID)
Number of mobile stations in the cell
Mobile station location distribution
Mobile station uplink/downlink (UL/DL) SINR distributions per sector
UL/DL traffic distribution per sector
Converged resource metrics per FFR sector
   In one embodiment, the mobile station location distribution is indicated by the mean and standard deviation of mobile station timing advances that are measured over the interval. In one embodiment, the mobile station uplink/downlink SINR distributions per sector are indicated by the mean and standard deviation of mobile station uplink/downlink SINR as measured per sector per interval.

In one embodiment, the UL/DL traffic distribution per sector are indicated by the mean and standard deviation of UL/DL traffic load samples on a per sector basis. On example illustration is provided below. The traffic load samples may count the number of octets of MAC PDUs (i.e., user data in MAC SDU, MAC headers, and MAC management messages) transmitted or received at the base station over the data sampling interval discussed above. UL/DL traffic distribution can be used to validate the performance of the self-optimization techniques.

In one embodiment, the SON server provides some or all of the following parameters to each base station:
FFR partitions
Power levels
Relative Load Indicator(s)
Time stamp change
   The FFR partitions are the partitions as illustrated in FIGS. 2 and 3.

In one embodiment, FFR partition parameters indicate the bandwidth or sub-carriers in OFDM terms to be allocated to each FFR partition. For example, in FIG. 2, if the total bandwidth is 10 MHz, then F_{1,d}+F_{1/3,a}+F_{1/3,b}+F_{1/3,c}=10 MHz. The FFR partition parameters may include four parameters to assign bandwidth to each partition. For example, F_{1,d}=7 MHz, F_{1/3,a}=F_{1/3,b}=F_{1/3,c}=1 MHz.

In one embodiment, power levels are provided for each partition. In one embodiment, the relative load indicator(s) are an indication of the average traffic of a base station in comparison with other base stations in the network. In one embodiment, the time stamp change is used to indicate when the new parameters should be effective for all base stations in the network.

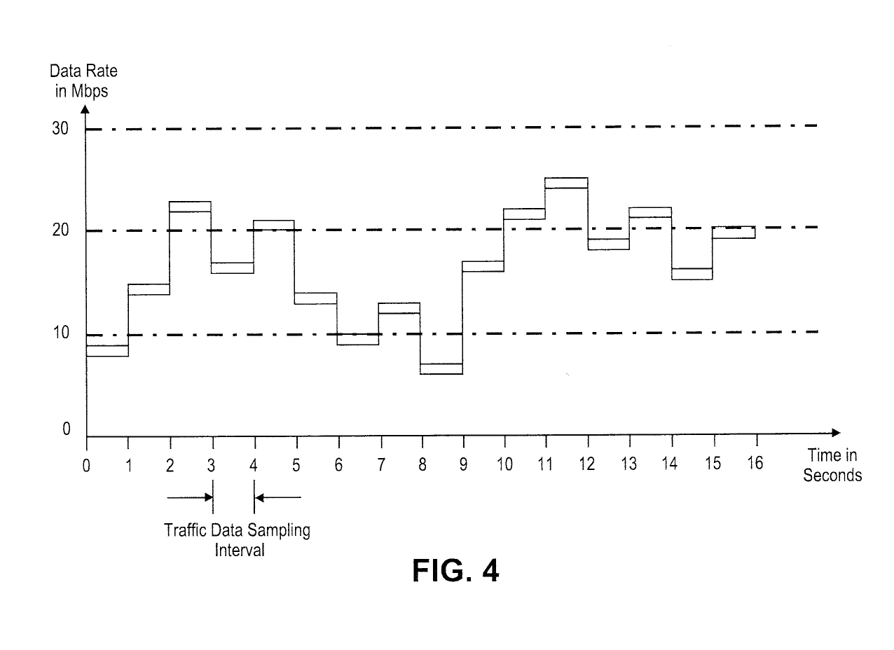

FIG. 4 is an example illustration of a data sampling that may be used for traffic load statistics over time. The example of FIG. 4 is provided in terms of data rate in megabits per second (Mbps); however, other metrics can also be used. In one embodiment, the data rate corresponding to each mobile station may be sampled periodically (e.g., every second) and the data rate samples may be used to compute the mean and standard deviation of traffic load statistics over time.

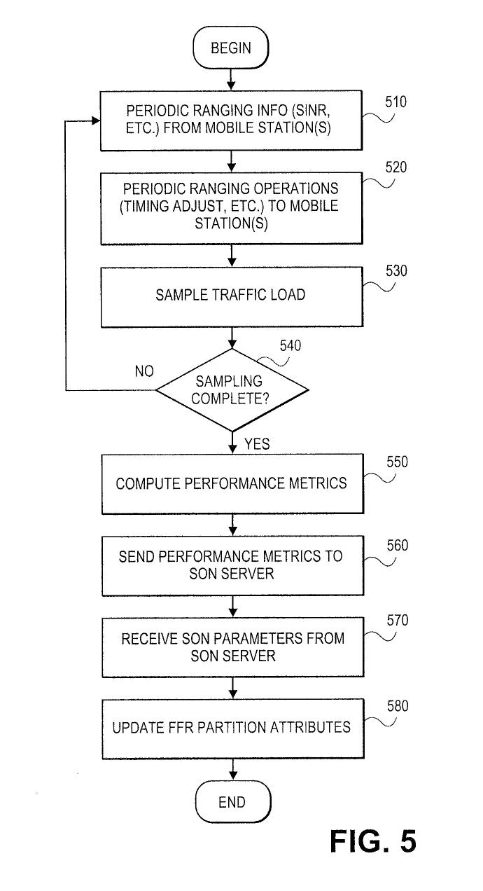

FIG. 5 is a flow diagram of one embodiment of a technique for fractional frequency reuse. The example of FIG. 5 is described from the perspective of the base station in each cell of a network.

The base station(s) receive periodic ranging information from mobile stations within the cell, 510. This received periodic ranging information can include, for example, DL SINR information. The base station(s) also transmit periodic ranging information to mobile stations within the cell, 520. This transmitted periodic ranging information can include, for example, timing adjustment information. In one embodiment, the traffic load is also sampled, 530.

If the sampling is not complete, 540, the periodic ranging transmissions (510 and 520) and the traffic load sampling (530) may continue. In one embodiment, the base station can measure mobile station distance from the base station via timing advance and SINR.

If the sampling is complete, 540, the base stations compute performance metrics for the cell and mobile stations within the cell, 550. Mobile stations may provide DL measurements to the base station. In one embodiment, the performance metrics include one or more of:
mean and standard deviation of timing advance
mean and standard deviation of UL/DL SINR
mean and standard deviation of UL/DL traffic loads
converged resource metrics
   The performance metrics are then transmitted to the SON server, 560.

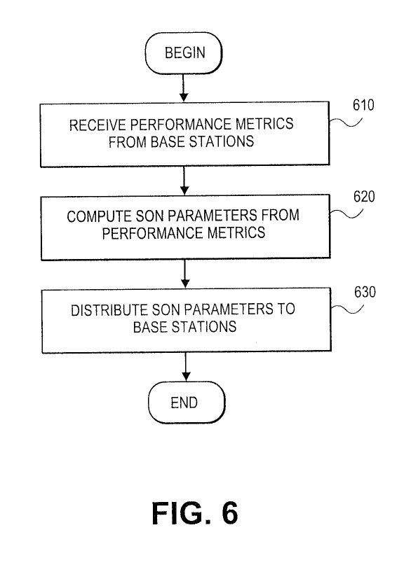

The SON server performs computations on the received performance metrics. The functionality of the SON server is discussed in greater detail below with respect to FIG. 6. The base stations receive SON parameters from the SON server, 570. In one embodiment, the SON parameters include parameters related to FFR. When the base station receives the SON parameters, the base station updates the FFR partition attributes, 580. The base station then uses the new FFR partition attributes.

The operation of the base station may be based on functionality of software, firmware, hardware or any combination thereof. Instructions are provided by a storage device, such as magnetic disk, a read-only memory (ROM) integrated circuit, CD-ROM, DVD, via a remote connection (e.g., over a network via network interface) that is either wired or wireless, etc. In alternative embodiments, hard-wired circuitry can be used in place of or in combination with software instructions. Thus, execution of sequences of instructions is not limited to any specific combination of hardware circuitry and software instructions.

FIG. 6 is a flow diagram of one embodiment of a technique for fractional frequency reuse. The example of FIG. 6 is described from the perspective of the SON server of a network. The SON server receives performance metrics from one or more base stations, 610 in each FFR partition update interval. Any number of base stations may be supported.

The SON server then executes a SON algorithm based on SON parameters from the performance metrics received from the base stations, 620. Example performance metrics that may be received from the base stations are listed above. The results of the algorithm by the SON server include FFR parameters to be transmitted back to the base stations. The SON server then distributes the SON parameters to the base stations, 630. In one embodiment, the SON parameters have an associated time at which they become effective. This allows all base stations to implement the SON parameters at the same time thereby reducing potential conflicts.

The operation of the SON server may be based on functionality of software, firmware, hardware or any combination thereof. Instructions are provided by a storage device, such as magnetic disk, a read-only memory (ROM) integrated circuit, CD-ROM, DVD, via a remote connection (e.g., over a network via network interface) that is either wired or wireless, etc. In alternative embodiments, hard-wired circuitry can be used in place of or in combination with software instructions. Thus, execution of sequences of instructions is not limited to any specific combination of hardware circuitry and software instructions.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving, from a plurality of base stations in a wireless network, performance metrics collected by the plurality of base stations, wherein the wireless network comprises a plurality of cells each having at least one base station and the performance metrics correspond to operation of the respective base stations and mobile stations communicating with the base stations;
analyzing the performance metrics from the plurality of base stations to generate network operational parameters including at least fractional frequency reuse parameters for a plurality of sectors in each cell and corresponding power values for the plurality of sectors for each base station;
transmitting to the plurality of base stations the operational parameters for the respective base stations; and
causing the plurality of base stations to operate according to the operational parameters.

2. The method of claim 1, wherein the performance metrics comprise a Base Station Identifier (BSID), a number of mobile stations in the cell, a mobile station location distribution, a mobile station uplink/downlink (UL/DL) SINR distribution per sector, and a UL/DL traffic distribution per sector.

3. The method of claim 1 wherein the performance metrics comprise a mean and standard deviation of timing advance, a mean and standard deviation of uplink/downlink (UL/DL) SINR, and a mean and standard deviation of UL/DL traffic loads.

4. The method of claim 1 wherein the wireless network comprises an IEEE 802.16-compliant wireless network.

5. The method of claim 1 wherein each sector is further divided into an inner region and an outer region where the fractional frequency reuse parameters are applied to communications with mobile devices in the inner region and a frequency reuse factor of 1 is applied to communications with mobile devices in the outer region.

6. The method of claim 5 wherein the fractional frequency reuse parameter comprises a frequency reuse factor of ⅓ and each cell comprises three sectors.

7. A wireless network comprising:
a server coupled with a plurality of base stations each to communicate with one or more mobile stations within a corresponding cell, the cells having a plurality of sectors, wherein the base stations collect performance metrics corresponding to operation of the respective base stations and mobile stations, the server receives the performance metrics from the plurality of base stations, analyzes the performance metrics to generate network operational parameters including at least fractional frequency reuse parameters for the plurality of sectors in each cell and corresponding power values for the plurality of sectors for each base station, and transmits the operational parameters to the plurality of base stations, wherein, in response to receiving the operational parameters from the server, the plurality of base stations operate utilizing the operational parameters.

8. The wireless network of claim 7, wherein the performance metrics comprise a Base Station Identifier (BSID), a number of mobile stations in the cell, a mobile station location distribution, a mobile station uplink/downlink (UL/DL) SINR distribution per sector, and a UL/DL traffic distribution per sector.

9. The wireless network of claim 7 wherein the performance metrics comprise a mean and standard deviation of timing advance, a mean and standard deviation of uplink/downlink (UL/DL) SINR, and a mean and standard deviation of UL/DL traffic loads.

10. The wireless network of claim 7 wherein the plurality of base stations each communicate with the one or more mobile stations according to an IEEE 802.16-compliant wireless network.

11. The wireless network of claim 7 wherein each sector is further divided into an inner region and an outer region where the fractional frequency reuse parameters are applied to communications with mobile devices in the inner region and a frequency reuse factor of 1 is applied to communications with mobile devices in the outer region.

12. The wireless network of claim 11 wherein the fractional frequency reuse parameter comprises a frequency reuse factor of ⅓ and each cell comprises three sectors.

13. An article comprising a computer-readable medium having stored thereon instructions that, when executed, cause a server of a wireless network to:
receive, from a plurality of base stations in a wireless network, performance metrics collected by the plurality of base stations, wherein the wireless network comprises a plurality of cells each having at least one base station and the performance metrics correspond to operation of the respective base stations and mobile stations communicating with the base stations;
analyze the performance metrics from the plurality of base stations to generate network operational parameters including at least fractional frequency reuse parameters for a plurality of sectors in each cell and corresponding power values for the plurality of sectors for each base station;
transmit to the plurality of base stations the operational parameters for the respective base stations; and
cause the plurality of base stations to operate according to the operational parameters.

14. The article of claim 13, wherein the performance metrics comprise a Base Station Identifier (BSID), a number of mobile stations in the cell, a mobile station location distribution, a mobile station uplink/downlink (UL/DL) SINR distribution per sector, and a UL/DL traffic distribution per sector.

15. The article of claim 13 wherein the performance metrics comprise a mean and standard deviation of timing advance, a mean and standard deviation of uplink/downlink (UL/DL) SINR, and a mean and standard deviation of UL/DL traffic loads.

16. The article of claim 13 wherein the wireless network comprises an IEEE 802.16-compliant wireless network.

17. The article of claim 13 wherein each sector is further divided into an inner region and an outer region where the fractional frequency reuse parameters are applied to communications with mobile devices in the inner region and a frequency reuse factor of 1 is applied to communications with mobile devices in the outer region.

18. The article of claim 17 wherein the fractional frequency reuse parameter comprises a frequency reuse factor of ⅓ and each cell comprises three sectors.
